(19) United States
(12) Patent Application Publication
(10) Pub. No.: US 2025/0278766 A1
(43) Pub. Date: Sep. 4, 2025

(54) GOODS AND SERVICES CONTENT SELECTION BASED ON ENVIRONMENT SCANS

(71) Applicant: Adeia Guides Inc., San Jose, CA (US)

(72) Inventors: Jean-Yves Couleaud, Mission Viejo, CA (US); Tao Chen, Palo Alto, CA (US); Ning Xu, Irvine, CA (US)

(21) Appl. No.: 18/591,612

(22) Filed: Feb. 29, 2024

(51) Int. Cl. G06Q 30/0601; G06T 19/00; G06T 19/20; G06V 20/20

(52) U.S. Cl. CPC G06Q 30/0603; G06Q 30/0631; G06T 19/006; G06T 19/20; G06V 20/20; G06T 2210/04; G06T 2219/2004; G06T 2219/2024

(57) ABSTRACT

The present disclosure is directed to systems and methods for selecting objects and content items related to a given environment. In some embodiments, the systems and methods receive a mapping of the environment and extract layout, available space, and existing object data of the environment from the mapping. The systems and methods receive a storage of supplement content items, and select a supplemental content item from the storage of content items based on the received mapping. The systems and methods may further select the supplemental content item based on a user profile received from a data source. The systems and methods then generate for display the supplemental content item on a device to a user.

### BACKGROUND

The present disclosure is related to systems and methods for scanning and analyzing a real-world environment to present recommendations, such as via unique content items, for enhancing use of the environment. The systems and methods may further select and recommend objects and/or services for better utilizing or making improvements to the environment.

### SUMMARY

Updating or enhancing an environment (e.g., one or more rooms in a home) is generally a quite manual process that depends on a user to identify areas for modification or improvement, and to find the solutions, or products, him or herself. Systems and applications intended to assist in visualizing changes to an environment do exist, such as those in which a user may select a product and, using AR, project a realistic image of that product into the environment, e.g., overlaying an image of a television in a room. However, such AR applications generally depend on the user initially discovering the products to place (e.g., the user selects a television to place in the room), and identifying a particular location in the environment to place the product (e.g., the user wishes to place a television in an open space on an entertainment center).

There also exists applications for mapping real world environments, including objects within the environment, for the purpose of creating a representation of the environment. A robotic vacuum, for instance, may develop a mapping of a room to determine where to vacuum. Such applications, however, are not designed to assess the spatial information and other relevant information regarding the real-world environment to make recommendations that would help to improve or enhance the environment.

The present disclosure relates to systems and methods for analyzing various types of environmental information to recommend and provide visualizations of improvements to real-world environments. For example, the systems and methods may analyze the representations and data to extract spatial information of the given environment. The present disclosure provides techniques for analyzing the available representations or data of an environment, and based at least in part on that analysis, selecting goods or services for the environment. After making a selection, a computing device may present, to a user, a content item depicting or otherwise representing the good or service. The content item may be, for example, an image or video displayed to a user on a user computing device, such as a smartphone or augmented reality device. In some embodiments the content item illustrates the improvement by, for example, displaying an image of a selected product in a representation of the environment itself. In some embodiments, the same user device displaying the content item may also provide at least some of the data of the environment. For example a VR headset may generate scans or images of the environment and produce a representation of the environment including a selected product therein.

The present disclosure describes systems and techniques for integrating environment data into a content item selection processes. Multi-dimensional scans and other spatial information are collected for various spaces. For example, an XR gaming headset might capture a user's space while preparing motion boundaries. In another example, existing software may generate three-dimensional renderings of a space based on images of that space on a user's phone. In another example, home electronics, such as a robotic vacuum cleaner may log spatial information on which a rendering may be based. In some embodiments, the present disclosure may collect and incorporate data from adjacent or nearby environments into the content item selection process. In some embodiments, a system may receive spatial information and create multi-dimensional renderings itself based on that data. In some embodiments, a system may receive already created renderings.

In one approach, the systems and techniques receive an inventory of available or offered products. The described systems and techniques then select, based on the spatial information or renderings, a product from the inventory that best suits the space. For example, the system might choose the product that best fills an empty space, that best matches a room's décor, that best replaces an existing object, and/or that best addresses a product absence. The system may also select or generate content items based on spatial information about nearby environments. For example, the system may determine that a specific product is not recommended for an area of the environment in a field of view based on information that another (perhaps nearby) area or field of view contains the same or similar product. In some embodiments the environment comprises a space beyond a present field of view, such as alternative fields of view of the same space, nearby rooms or spaces, or related spaces. Once the system selects the product or service, it may display a depiction of the product or service to the user as a content item. In one example, the content item shows an image of the product installed in the environment. The content may also be, for example, a three-dimensional object that can be sized and placed in an VR or AR environment to represent a real world item in the environment. In this way, the disclosed systems and techniques generate highly personalized content items unique to each user.

The disclosed personalized content selection system generates recommendations tailored to a specific environment without requiring user input, awareness, or intent with respect to potential improvements. It further creates a unique representation of the environment including the recommended products or services, and may take into account neighboring environments.

### BRIEF DESCRIPTION OF THE DRAWINGS

FIG. 1 shows an example process in accordance with some embodiments of the present disclosure;

FIG. 2 shows an example architecture of some embodiments of the present disclosure;

FIG. 3 shows an example process of some embodiments of the present disclosure;

FIG. 4 shows an example three-dimensional mapping of some embodiments of the present disclosure;

FIG. 5 shows an example three-dimensional mapping of some embodiments of the present disclosure;

FIG. 6 shows an example of the object selection process of some embodiments of the present disclosure; and

FIG. 7 shows an example process in accordance with some embodiments of the present disclosure.

### DETAILED DESCRIPTION OF THE DRAWINGS

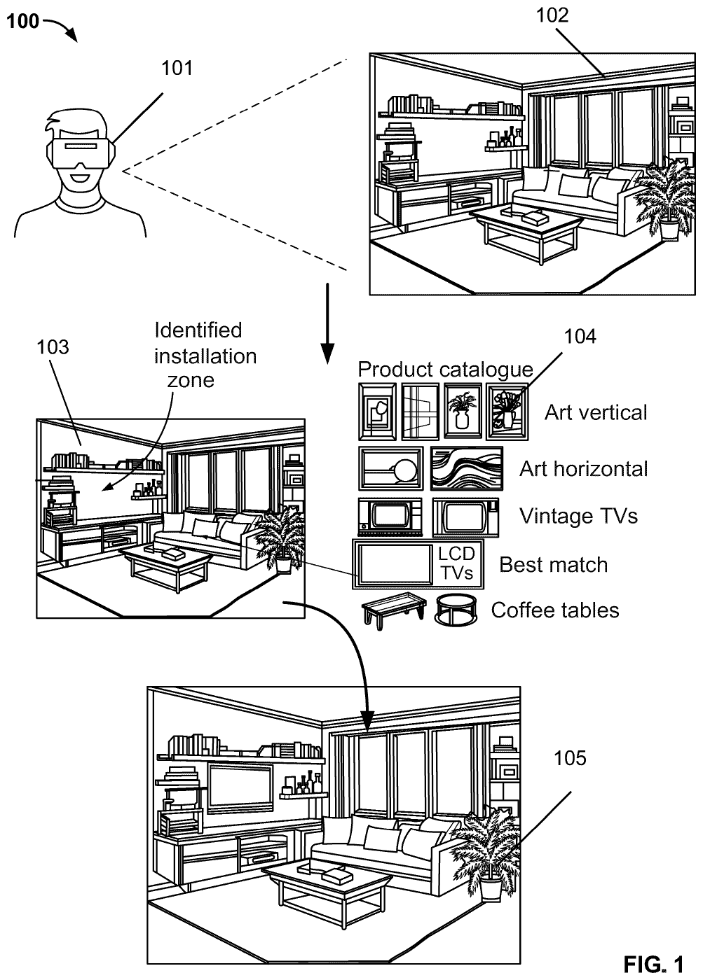

FIG. 1 shows an illustrative embodiment of a content selection system 100 that displays content on a primary device based on spatial information collected at a secondary device. At a first step, a secondary device 101 collects spatial information of a three-dimensional, physical or real-world environment 102, such as a user's living room. The device 101 may be an XR headset, smartphone, camera, or any other device capable of collecting spatial information of physical or real-world environments. Such devices may collect images or other data that, after analysis or processing, may inform a three dimensional rendering or mapping of the environment 102. The content collection system 100 may analyze images, rendering, mapping, raw data, or other information to catalog locations or objects within the environment 102. In this example, the content selection system 100 uses the collected spatial information to generate a mapping 103 of the environment 102 or otherwise analyze the environment 102, as discussed in more detail below. The mapping 103 may document physical aspects of the environment 102 such as, for example, dimensions, empty space, a layout, or a color scheme. The mapping may be a 3D rendering of the environment 102 as shown in FIG. 1. In some embodiments, it is a 2D image, e.g., a floorplan or a mapping of a wall or other area. In some embodiments, it is data stored on the content selection system 100 that content selection system 100 may or may not represent to the user. The secondary device 101 may collect the spatial information by, for example, scanning the environment 102 or capturing images of the environment 102. The secondary device 101 may be any device capable of these actions for mapping, such as an extended reality (XR) wearable device (e.g., a virtual reality (VR) or an augmented reality (AR) headset), a smartphone, tablet, or a house automation robot capable of two-dimensional scanning (e.g., an automated vacuum, or a robotic lawnmower, or a robot capable of three-dimensional scanning such as Amazon's Astro). The environment 102 may be any real-world area. For example, a room for which a user might purchase electronics (e.g., a television or speakers), furniture (e.g., a sofa or coffee table), or other items (e.g., art, decor, or fitness equipment). The content selection system 100 is configured to create or receive the mapping 103 and, based at least in part on the mapping, to select goods and/or services 104 that are adapted, needed, or desired for the environment 102. In some embodiments, the content selection system 100 receives permission, such as from secondary device 101, to use acquired scans or mapping 103. The permission may be received via a setting or a pop-up icon requesting access to data.

In some embodiments, the content selection system 100 may scan or otherwise collect and store data on more than one more environment, such as a room, field of view of a house on a device 101, or other enclosure or area. In such embodiments the various regions may inform the content selection system 100 of each other, building on knowledge to map a complete dwelling. For example, data on adjacent regions might inform the content collection system 100 about lighting in a room. One instance of this situation might occur if a room has no windows, but because it borders a bright room with large windows and a skylight, that same room receives sunlight throughout the day.

In some embodiments the content selection system 100 selects the content item representing the goods and/or services 104 from a storage of goods and services or content items related to the goods and/or services 104. Content items 105 may be, for example, content illustrating the goods and/or services 104, such an image of goods, an image of the results of a service, an advertisement for a good, a video review of the goods or services, a two or three-dimensional representation of a goods or service, etc. FIG. 1 shows content item 105 as an altered image of the environment 105 that includes a realistic representation of the goods and/or services 104, here a TV, in the environment 102. The content selection system 100 may alter the size position, rotation or coloring of a content item 105 for optimal presentation. For example, in the case of displaying a content item 105 on an AR device, the content selection system 100 may rotate and enlarge an overlay content item 105 to most realistically integrate into an existing environment 102. The selection may be based on, for example, determining an available, underutilized, or empty area in the environment 102.

In some embodiments, the content selection system 100 may, using mapping 103, catalog the existing objects in the environment 102 to identify needs for or deficiencies of goods and/or services 104. In some embodiments, the needs or deficiencies of an environment 102 are based on data on surrounding or related environments 102, such as an adjacent or nearby room. The cataloging may include details or characteristics of each existing object cataloged, such as type of object, requirements for the object such as electricity or network connectivity, potential services related to the object, or make, model, year, color, style, dimensions, and price range of each existing object cataloged. In some embodiments, a third party or other resource provides a catalog. In some embodiments, the content collection system 100 builds a catalog from a collection of goods and services 104. The content system 100 may collect data regarding the goods and services such as make, model, year, color, price, availability, etc. It may then store this data for use in selecting a content item 105.

The content selection system 100 may then next use these object details or characteristics, as well as or in place of, inferring available area in environment 102, to select goods and/or services 104 for the environment 102. The goods and/or services 104 may be a subset of goods offered for sale, for example. These goods may include objects, such as televisions, furniture, artwork, or other items that are likely to be placed in an environment 102. Services may include cleaning services, such as window washing or housekeeping, repair services, such as plumbing or woodwork, or services specifically related to an environment 102, such as organizing for a large closet. In some embodiments, the content selection system 100 infers one or more available regions in environment 102 for the goods or services 104. For example, content selection system 100 may identify an empty wall for a bookcase or an outdating rug to be replaced. In some embodiments, the content selection system 100 detects objects or regions in environment 102 that might be replaced based on inefficiency or other criteria. For example, the content collection system 100 might detect a bookcase and determine that the bookcase would be more efficient as a murphy bed. In another example, the content collection system 100, might detect a couch that is out of style and that a replacement would better fit the aesthetic of the environment 102.

The content selection system 100 may next create a content item 105, such as an image shown in FIG. 1 displaying the goods and/or services 104 in a rendering of the environment 102. The rending may be based on the mapping 103 discussed above and any other available data on the environment 102, in combination with data regarding three-dimensional properties of the goods and/or services 104. The rendering may further include details such as realistic lighting of the environment 104 and goods and/or service 104 in the content item 105. The rendering may be for example a virtual rendering in VR, a 2D unique generated image, or a view through AR. In some embodiments the content selection system 100 generates the content item 105 as an audio representation of the goods and services 104 in environment 102 either in place of or in addition to an image. In such an embodiment, the content selection system 100 may determine acoustic properties of an environment 102 from a mapping 103. The content selection system 100 may also consider audio specifications of the goods and/or services 104 and incorporate those details into content item 105. In some embodiments the content item 105 is a profile of a good or service where the profile is content that contains information dedicated to the good or service, such as an advertisement. For example, the content item 105 may be an advertisement that discusses the features of the goods and/or services 104. Such a content item 105 may be generated according to a template in one example. In some embodiments, content selection system 100 may select an existing content item 105 from an object storage containing a collection of content items 105, as opposed to generating a new or custom content item 105. For example, the content selection system 100 may select an advertisement from a collection of advertisements in an advertisement store to display as content item 105. The advertisement may correspond to a selected goods and/or service 104.

The content selection system 100 transfers the content item 105 to a user device, the primary device, where the user device displays the content item 105. In embodiments in which the content item 105 is an advertisement, the user device displays the content item 105 as an advertisement for a user to receive and potentially select. The user device may be any device which displays media such as a personal computer, smart phone, TV, tablet, XR device, or other devices. In some embodiments, the media is an advertisement. A user may select an advertisement when the user clicks on the advertisement of otherwise provides input of a selection. Selecting the advertisement may take the user to a product page or other portal offering more information or purchase opportunities. This content selection system 100 allows an advertisement platform, such as a browser, social network, or an e-commerce platform to infer goods and services needs of a user by using mapping and imaging information captured through their use of a secondary device 101. In some embodiments, the content selection system 100 creates a unique image of environment 102 using mapping 103 and displays that image to the user. In some embodiments, the unique image includes content item 105 which displays a good and/or service 104 in the environment 105. In some embodiments, the display of content item 105 is an overlay generated over an image of environment 102. Such embodiments might require that the content item 105 be resized and/or reoriented to properly represent what the good or service 104 will look like in the environment 102. In some embodiments, content items 105 might further require that content system 100 further adjust shadows, highlights, and other external factors to create a realistic representation of a good or service 104. In those embodiments, content selection system 100 further processes content item 105 to ensure the correct placement and appearance of the content item 105 in the environment 102. In some embodiments, in which the content item 105 is related to a service, content selection system 100 may display a representation of environment 102 showing the service having been performed as a content item 105. For example, if the content item represents a window cleaning service, the content selection system 100 might display an image of environment 102 with clean, sparkling windows as a content item 105. In another example, if the content item represents a room cleaning service, the content selection system 100 might display a video showing a scan of environment 102 clean and neat, as a content item 105. In another example, if the goods or service 104 generates a sound, such as is the case with a new speaker, the content selection system 100 might display an image of the environment 102 with the speaker and the sound of the speaker playing music as content item 105. In some embodiments, the content selection system 100 may consider the acoustic qualities of a room determined by the mapping 103, and reflect those qualities in the content item 105.

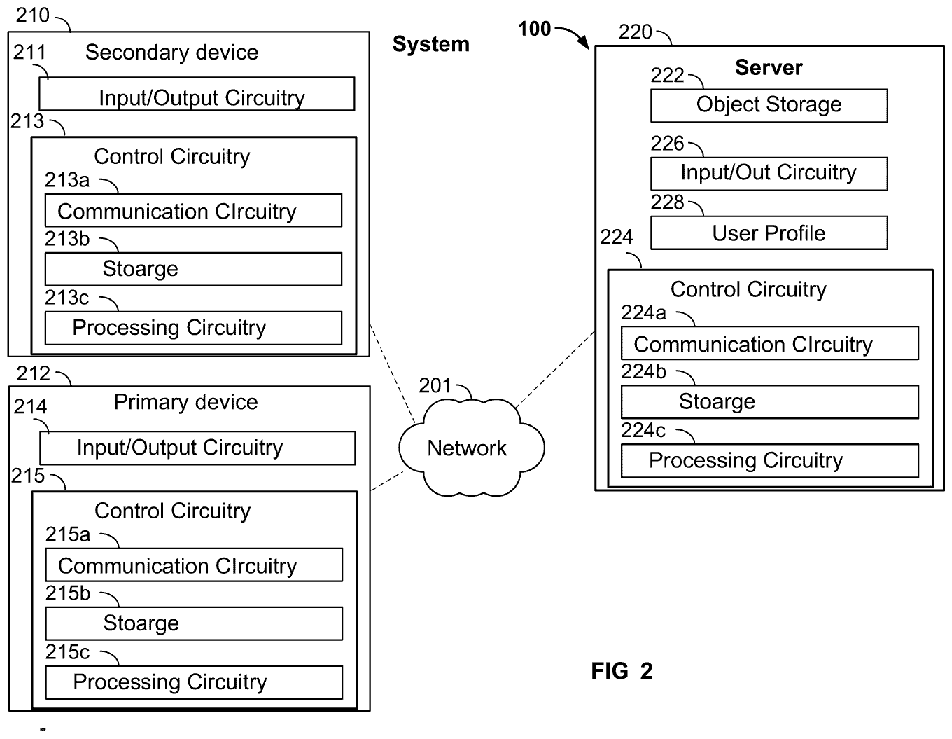

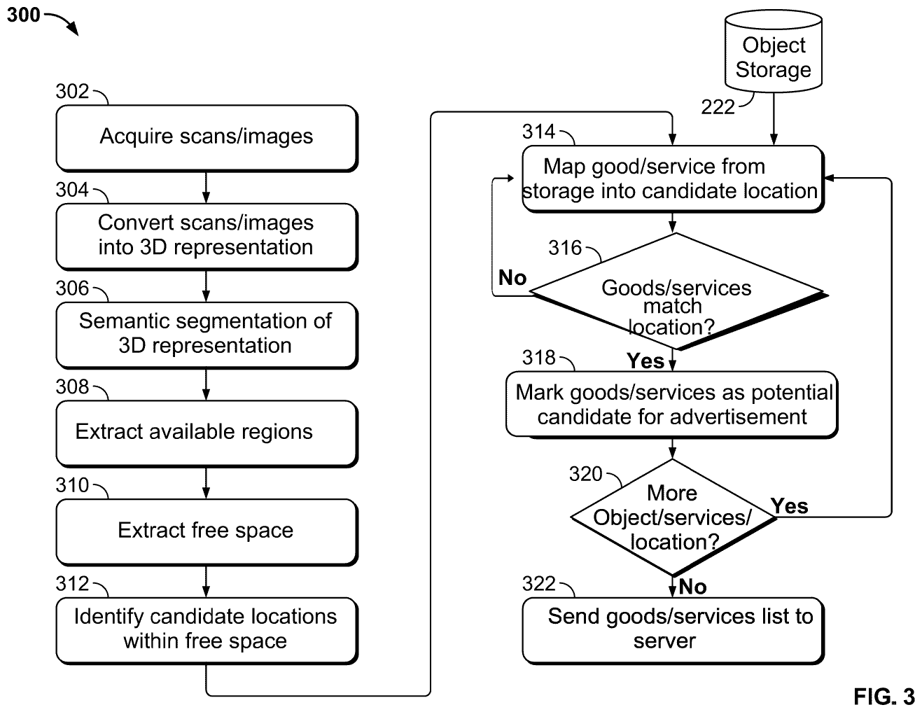

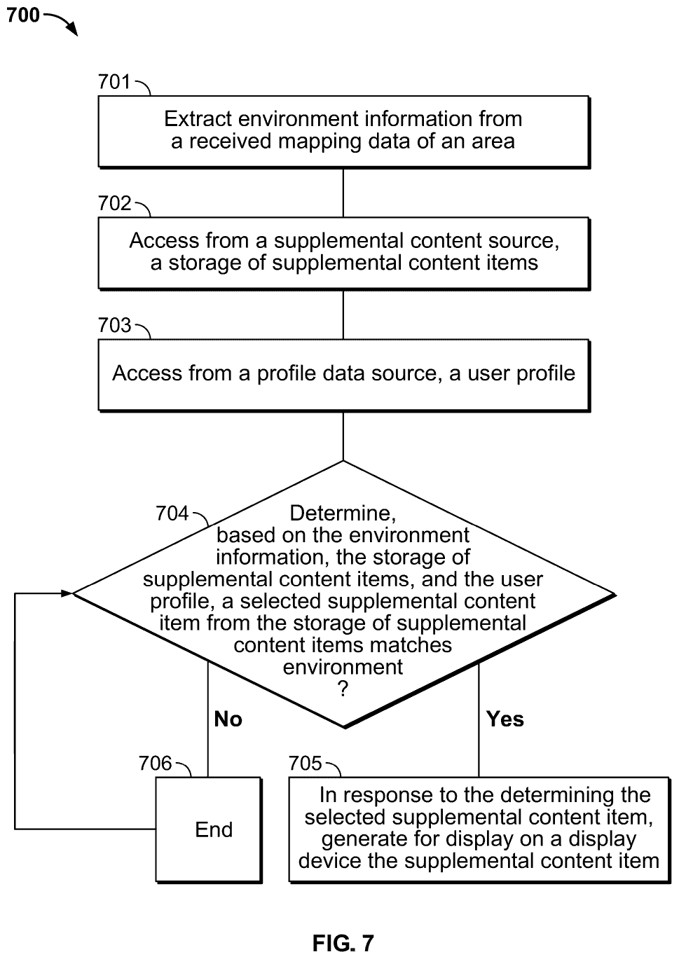

FIG. 2 shows an example system architecture of content selection system 100. Content selection system 100 includes server 220 which in some embodiments performs the primary functions of the disclosure such as those described below in FIGS. 3 and 7. Control circuitry 224 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 224 in turn includes communication circuitry 224a, storage 224b and processing circuitry 224c. Control circuitry 224 may be utilized to execute or perform any or all the systems, methods, processes, and outputs of one or more of FIGS. 1-7, or any combination of steps thereof.

In some embodiments, control circuitry 224 executes instructions for an application stored in memory (e.g., storage 224b). Specifically, control circuitry 224 may be instructed by the application to perform the functions discussed herein. In some embodiments, any action performed by control circuitry 224 may be based on instructions received from the application. For example, the application may be implemented as software or a set of and/or one or more executable instructions that may be stored in storage 224b and executed by control circuitry 224. The application may be a client/server application where only a server application resides on server 220.

Content selection system 100 includes secondary device 210, which may capture a scan and/or mapping 103 of a three-dimensional environment 102. Secondary device 210 may be any device with scanning capability, such as an XR headset, camera, or smartphone. In some embodiments, the scan may be produced from existing images that may be compiled to infer information regarding the environment 102. Secondary device includes input/output circuitry 211 which may receive and transmit data as well as control circuitry 213 with similar features and capabilities of control circuitry 224. The content selection system 100 also includes a primary device 212 for displaying images or other content items. The primary device 212 may be, for example, a smartphone, television, tablet, XR headset, or computer. In some embodiments, the primary and secondary device 212, 210 are the same device where primary device 212 has scanning capabilities and secondary device 210 includes a user interface or display. Primary device includes input/output circuitry 214 which may receive and transmit data as well as control circuitry 215 with similar features and capabilities of control circuitry 224. The primary and secondary devices 212, 210 are connected via a network 201. The network 201 may be any informational network, such as the Internet. The network 201 further connects the primary and secondary devices 212, 210 to a server 220. The server 220 receives the scan and/or mapping 103 from the secondary device 212 and processes this information in a processor 224. In some embodiments, processor 224 analyzes a scan of environment 102 to create a mapping 103. The server may also receive additional information from a database, the primary device 212, or the secondary device 210, such as information regarding a user's preferences, history, or any other relevant information. In some embodiments, information regarding a user's preferences, history, areas 102, or other user data is stored in a user profile 228. In some embodiments, the functions and processes of the server may take place on the devices 210 and/or 212 using, for example, processors and memories within those devices. The server 220, via processor 224, analyzes all information and selects, based on the information, an object or objects, such as goods and/or services 104 from the object storage 222, which stores a collection of objects or content items 105 related to an object such as images or advertisements. In some embodiments, the system selects an object first and then, in response to that selection, selects or generates a content item related to the object. The server then may, in some embodiments, generate a content item including, for example, a selected image or advertisement, using processor 224. The content selection system 100 then sends or causes to be displayed the generated content item 105 on the primary device 212.

FIG. 3 shows a flow diagram of an example process 300 of content selection system 100. The steps of process 300 may take place primarily on one device or may take place among several devices including, for example, a cloud server. The process 300 begins at step 302 when a secondary device, such as secondary device 210, akin to secondary device 101, acquires data, such as scans or images of a three-dimensional space, akin to environment 102. The data may be acquired by the device itself using, for example, a camera, or may be received from another source. The secondary device 210 may acquire the data through, for example, an internal camera which captures images of the environment 102. In some embodiments, secondary device acquires data and scans through distance detection, such as proximity detection, SLAM, LIDAR, or infrared sensors.

In some embodiments, the content selection system 100 may detect multiple scans for a particular environment 102, a room for example, or may detect that the user spends an extended period of time in that particular location. For example, if the scan has been acquired by a robot, the object segmentation may extract the user or other individuals. Upon such detection, the content selection system 100 may rank content items for objects fitting that environment 102 higher than other objects fitting other locations also related to the user. By doing so, the content selection system 100 assumes that the user spends more time at that location than others and hence allocates more weight to content for objects related to that environment 102. Additional weighting may take into account other parameters, such as the time of the scans as well. For example, a scan of an environment 102 taken at night, while normally might indicate that a room is not popular, might not assume that conclusion due to the fact that activity is low during certain hours.

A processor, such as processor 224, then at step 304 converts the acquired data into a mapping 103 of the space. For example, processor 224 may create a mapping 103 that is an image or layout, such as a floor plan, of the environment 102 based on the acquired data. Processor may alternatively or additionally create three-dimensional models of the environment 102 based on the data. This step may take place, for example, at a server or a primary or secondary device 212, 210.

At step 306 a processor (e.g., processor 224) may segment the mapping 103 using semantic segmentation. The segmentation allows for identification of objects, color schemes, textures, layout of the environment, and regions of the environment, among other purposes. This step may also take place, for example, at a server or a primary or secondary device.

The processor 224 then at step 308 extracts and identifies objects, such as furniture, electronics, lighting, artwork, electrical outlets, windows, or other elements, within the environment 102 using the segmentation and object recognition processes. The content selection system 100 then may catalog the identified objects in environment 102 to inform the selection of content item 105. For example, existing objects in environment 102 may inform the selection in that the content selection system 100 may avoid content items 105 that are redundant or unnecessary given the existing objects. In another example, the content selection system 100 may select content items 105 related to a need in the environment 102 based on the existing objects. For example, content selection system 100 in one embodiment might recognize a dining room but no chairs. The content selection system 100 may then select content items 105 promoting dining room chairs. The processor may also analyze the mapping 103 to determine additional information, such as color scheme, style, or budget. This additional information may further inform the selection process as goods and services 104 that match a color scheme, style, or budget are most desirable. In some embodiments, the content selection system 100 extracts the dominant color for each of the objects identified in the room, and these colors are converted into text to perform a metadata mapping with the goods and services. For example, the content selection system 100 may choose a content item 105 promoting a white couch for a room that has mostly white furniture.

To determine style information, the content selection system 100 may create or receive two-dimensional representations of an environment 102 based on data from one or a series of cameras. The data may contain color or texture information in some embodiments. An image-to-text model fine-tuned on style may then assess the representations to extract the style of the environment 102. Similarly, to determine budget information, an image-to-text model fine-tuned for cost-analysis may assess the representations to extract a budget of environment 102. The extracted budget may in some embodiments be an estimate based on a user profile or the objects or other details of the environment 102. In some embodiments, a user may provide a budget range. In some embodiments, the budget classifier need not be precise and, in some embodiments, the budget classifier outputs a range of cost.

At step 310 the processor analyzes the mapping 103 to determine and extract empty or available regions within the space in which an object, such goods and/or services 104, may fit. For example, the mapping 103 may show empty regions of environment 102, such as a wall with no decoration or an empty corner. These regions may be available for new goods and services 104. In some embodiments, the content selection system 100 determines available regions based on determined empty spaces. In some embodiments, for example embodiments in which existing items are replaced, the content selection system 100 determines these regions through characteristics of the regions. In some embodiments, determining available regions includes determining measurement of the environment 102 or the region, as well as other characteristics, such as color, lighting, access to electrical outlets, and any other information that might inform the content item 105 selection process.

At step 312, the process 300 then identifies, using a processor (e.g., processor 224), candidate locations for objects within the free space determined at step 310. For example, as discussed above, content selection system 100 may select empty regions for placement of goods and/or services 104. In some embodiments the content selection system 100 replaces existing items in addition to or instead of determining available, unoccupied, or underutilized regions for new items. These replaceable objects may be selected from a catalog of recognized objects similar to above step 308. In such embodiments, the system 100 may not perform step 310 as the object replaces an existing object and does not require a new space. When a region's characteristics match those a good or service 104 requires, the content selection system 100 may determine that region to be a candidate for the good or service 104. For example, if the content selection system 100 recognizes that a living room has only chairs, it might recommend replacing the chairs with a sofa. It might then identify a region of the living room as available for a sofa if the region has the required dimensions for a sofa and does not include a window or a door to avoid blocking these features with the proposed sofa. Other characteristics may also be relevant, such as a window position relative to a screen, internet connection strength for internet connected devices, optimizing walk through flow of a room, style preferences, or budget considerations for fixtures that require plumbing.

Once the content selection system 100 has determined locations for goods and/or services 104 within the environment 102, it may then select goods and/or services 104 and create, or retrieve from an outside source, a representation of those goods and/or services 104 in the environment 102. To select goods and/or services, process 300 first maps goods and/or services 104 from an object storage, such as goods and/or services 104 from object storage 222, into the locations determined at step 312.

At step 316 the process 300 determines if an item matches a location, such as the empty or available space determined at step 310. An item may match a location if, for example, an associated object or service physically fits the location, meets budget or style requirements of the location, or the location meets the needs of the items, such as providing access to an electrical outlet or limiting UV exposure. If a good and/or service does not match, for example the item does not physically, visually, and/or financially fit, the process 300 returns to step 314 and selects another good and/or service for mapping. If the good and/or service does match, the process moves to step 318 in which the process 300 marks the good and/or service as a potential candidate for advertisement or other representation.

The process 300 then moves to step 320 to determine if more goods and/or services or locations are available. If the process 300 determines that more goods and/or services or spaces are available, it returns to step 314 to map additional objects. If at step 320 the process determines that more goods and/or services or spaces are not available, it proceeds to send the list of identified goods and/or services to an advertising server, or other supplemental content server, at step 322. From the advertising or supplemental content server, the content selection system 100 generates a content item 105 for display on primary device 212, the content item 105 being related to the selected good and/or service.

In yet another embodiment, the content selection system 100 may also measure the efficiency of the content item 105 showing goods and/or services 104 in relation to a mapping of an environment 102 by monitoring changes to that environment 102 obtained by subsequent scans and mappings 103. For example, an updated mapping 103 of an environment 102 may show that content item 105 was successful if the related good or service appears in updated mapping 103 but not in the original mapping 103. Further to that determination, the content selection system 100 may also detect if the location of that new good within the environment 102 matches the location originally forecast for such good. Upon determining that the location is different, the content selection system 100 may adjust its object installation model accordingly. If the location is accurately predicted the object installation model may be promoted within content selection system 100.

In some embodiments, the content selection system 100 may also use predictive analysis based on set rules or using a trained model to forecast a future need of an object based on a digital representation of an environment 102. For example, after obtaining a first scan of an empty bedroom, then a second scan a few months later of the same bedroom now containing a crib, the content selection system 100 may infer the need for a children's bed and an associated timeline. Such historical information may be stored, in some embodiments, in user profile 228 which include historical information as well as changes to an environment 102.

In some embodiments, the content selection system 100 may rearrange existing objects in an environment 102. In such an embodiment, the content selection system 100 creates a catalog of objects as discussed above and, after obtaining a mapping 103 of the environment 102, determines alternative locations for the objects. In such embodiments the content item 105 created may be, for example, a new furniture layout floor plan or a three-dimensional, or XR, rending of the updated arrangement. These embodiments may be useful in rearranging furniture or making space for additional objects.

In some embodiments, the content selection system 100 may arrange existing objects in a new environment 102. For example, system 100 may catalog existing objects and place them in a new environment 102. Such embodiments may be useful when a user moves to a new dwelling and would like to imagine existing furniture or other items in the new home. In such embodiments the content selection system 100 may obtain mappings 103 of the new home from real estate listings or traditional scans.

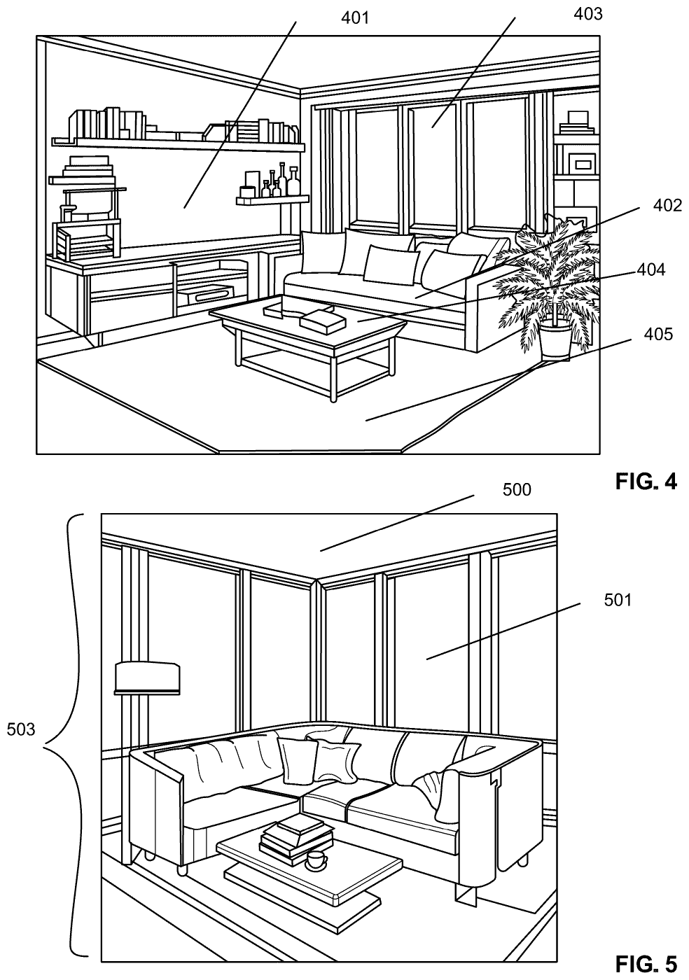

FIG. 4 shows an example three-dimensional mapping 103. In some embodiments, the content selection system 100 may acquire a three-dimensional scan, which may include color imaging information, of a user's room, or environment 102, when a user uses a VR headset in a room. In some embodiments, the content selection system 100 may acquire a two-dimensional scan when the room is cleaned by a robotic vacuum cleaner. In some embodiments, the content selection system 100 may collect data on multiple related environments 102. For example, in some embodiments, the content selection system 100 may receive a scan of each room in a house. By collecting scans of an environment 102, content selection system 100 either receives or generates a mapping 103 of the environment 102 that contains spatial and visual information of the environment 102.

Content selection system 100, in some embodiments, infers adequate locations for goods and/or services 104 based on a mapping 103. For example, FIG. 4 shows an empty space on the wall on the left. The content selection system 100 may recognize this as an available region 401 and a location for a television or artwork. In some embodiments, content selection system 100 considers additional information from the mapping 103, scan, or images of environment 102 that might impact location. Such additional information might include lighting, UV exposure, electrical outlet locations, or walkways for example. This information may come from object recognition discussed in step 308 in which content selection system 100 identifies objects, such as sofa 402, windows 403, table 404, and rug 405. In some embodiments, content selection system 100 infers the goods themselves, deciding goods and/or services 104 that are useful in the environment 102. For example, the environment 102 shown in FIG. 4 appears to be a living room, which content selection system 100 may recognize through the object recognition of sofa 402, windows 403, table 404, and rug 405. The content selection system 100 may also identify that the room does not include a television and may suggest such a product to the user. Alternatively, the content selection system 100 may determine that an adjacent room includes a large television and instead suggest artwork for the living room as an additional television is not likely necessary. As discussed above, the content selection system 100 may select the objects, such as goods and/or services 104, from a storage, such as object storage 222. The content selection system 100 may select objects that best fit the available locations. In some embodiments, the content selection system 100 infers a design style, such as modern, farmhouse, or maximalist, and selects an object that best matches the identified style. In some embodiments, the content selection system 100 infers a budget range and selects an object that best matches the identified budget. In one embodiment the content selection system 100 uses mapping 103 and other available data to identify existing objects in the environment 102, stores those objects in a catalog of one or more recognized objects, and selects products based on those existing objects. For example, content selection system 100 might recognize that a user's living room has a television and based on that information will select artwork, instead of a second television, for placement on an empty space on a wall. In one embodiment the content selection system 100 might recognize that a neighboring room in a house has a television and will select artwork, instead of a second nearby television, for environment 102 in that scenario as well.

In one example embodiment, content selection system 100 scans a living room and selects a set of coffee tables matching the living room from an object storage 222 containing furniture. As a result, when the user uses an entertainment platform, such as a social media network or Internet-connected TV, that employs content selection system 100 to target consumers with advertisements, the user sees an advertisement for the selected coffee tables instead of a generic advertisement for a generic coffee table. Additionally, if color imaging data is also available and usable, the content selection system 100 may present a content item 105, such as an advertisement, showing the selected coffee tables installed in the user's own living room. The image may be created by rendering the model in which the new goods and/or services 104 have been inserted into a representation of environment 102.

In some embodiments, content selection system 100 determines based on a mapping 103 that a service is adequate for an environment 102. In an example embodiment, FIG. 5 shows a scan 500 of an environment 102, a living room with large windows 501. Based on the large windows 501, the content selection system 100 may determine that an advertisement of a window cleaning service or a blinds installation company may be adequate. In some embodiments, the content selection system 100 detects via mapping 103 the state of the window 501, such as the cleanliness of the windows, and generates content items based on that state. For example, content selection system 100 might generate a content item 105 for window cleaning upon recognizing that the windows are dirty, such as content item 503, which is an image of the environment 102 with 501 professionally cleaned.

In some embodiments, content selection system 100 includes a user profile 228, which stores user data, such as preferences, purchase history, history of environment 102, and other information. Content selection system 100 may use data in user profile 228 to select goods and/or services 104 for environment 102. For example, data in user profile 228 may indicate a preferred budget and style. Content selection system 100 may then select only goods and/or services that meet that style and budget in addition to physically fitting within the environment 102.

The content selection system 100, in some embodiments, may select a set of products that are relevant to the mapping 103 as there may be more than one product and/or service 104 in the object storage 222 that are relevant to the environment 102. The content selection system 100 may then rank each product and/or service 104 based on how well each matches the environment 102. Such determination may include dimensional analysis such as determining that the selected product covers a sizable portion of the detected available installation space within the mapping 103 and not just a small portion. Such determination may also include aesthetic considerations. For example, the content selection system 100 may determine, based on the mapping 103, that several pieces of furniture detected within the mapping 103 belong to a set and that the set includes another piece of furniture, not present in the mapping 103 but part of the object storage 222. In some embodiments, the content selection system 100 recognizes a design style of an environment 102, such as modern, farmhouse, maximalist, or traditional, and selects products, such as furniture or other objects that match that style. For example, content selection system 100 may select a bean-shaped table for an environment 102 with a midcentury modern style, but select a sturdy and traditional wood table for an environment 102 with a colonial style.

The content selection system 100 may use methods known in the art to generate a three-dimensional representation of an environment 102. For example, the content selection system 100 may use photogrammetry methods to reconstruct in three-dimensions the environment 102 based on a series of pictures of the space available, for example, on a social media platform. The content selection system 100 may use semantic segmentation to extract and identify objects from the reconstructed three-dimensional model and match these objects to object storage 222 for which it has full geometric information. The content selection system 100 may also use two-dimensional information to compute space allocation within an environment 102. For example, a robotic vacuum cleaner session log may be used to infer location of furniture (where the vacuum cleaner cannot go) changes in surface cover (i.e., carpet, rugs, wood floors, tiles, etc.) which may be sufficient to map certain goods (such as new furniture) and services (such as housekeeping services). The content selection system 100 may also detect three-dimensional objects directly from a point cloud capture such as those generated by a VR headset using methods known in the art. Once objects have been detected, the content selection system 100 may then infer free space in the environment 102 using known methods. Once the content selection system 100 determines free space, the content selection system 100 may then further segment that free space based on rooms and areas within rooms. For example, the content selection system 100 may detect an opening created by two shelves and separate it from an opening in front of a sectional sofa, so that different articles can be mapped for these different openings. In this way, the content selection system 100 generates a unique representation of environment 102.

In some embodiments, the content selection system 100 may determine that an object present within the mapping 103 may be replaced by an object from the object storage 222. That determination may be based on recognizing the object in the mapping 103 and determining that the object is past its useful life. In some embodiments, that determination may be based on detecting that the object style does not match the rest of the objects in mapping 103. In some embodiments, that determination is based on a user profile indicating the age of the object. In some embodiments, the content selection system 100 identifies objects in environment 102 and tracks their age and use. It then stores this information in a user profile. For example, the content selection system 100 may recognize a couch in environment 102. The content selection system 100 may recognize that two years later, the couch is in a different room. This relocation may indicate to the content selection system 100 that the couch no longer serves its original purpose and should be replaced. The content selection system 100 may then suggest a new couch and display a content item with that suggestion on primary device 212. In another example, the content selection system 100 may, eight years later, determine that the couch is ten years old, indicating to the content selection system 100 that an updated couch may be more stylish. The content selection system 100 may then suggest a new couch and display a content item with that suggestion on primary device 212. In another example, content selection system 100 may detect a crib in environment 102 and determine that environment 102 is a baby's bedroom. After two years, the content selection system 100 may detect that the crib remains in environment 102, and display content items 105 related to toddler beds, knowing that children often transition out of cribs sometime after two years and that the crib is likely to soon be replaced. Upon determining that the object may be replaced by an object from the object storage 222, the content selection system 100 may present a content item 105 featuring the object such as an advertisement for that replacement object. The content selection system 100 may also include a stock photograph or video of the old product as part of the content item to further personalize the content item. For example, an advertisement message might read, “Your old couch needs a refresh! Here's a new one!” while showing the old couch in the first portion of the advertisement and the new couch in a second portion. Methods such as the Visual Complements Model may be used to determine the visual appeal of an object within an environment 102 or as a replacement for an existing object within a set of objects and hence compute a desirability score for a particular object within a set and generate a content item 105 accordingly. In some embodiments, the generation of 2D images of the environment 102 using virtual cameras at different angles of the room may also contribute to determining the visual appeal of an object.

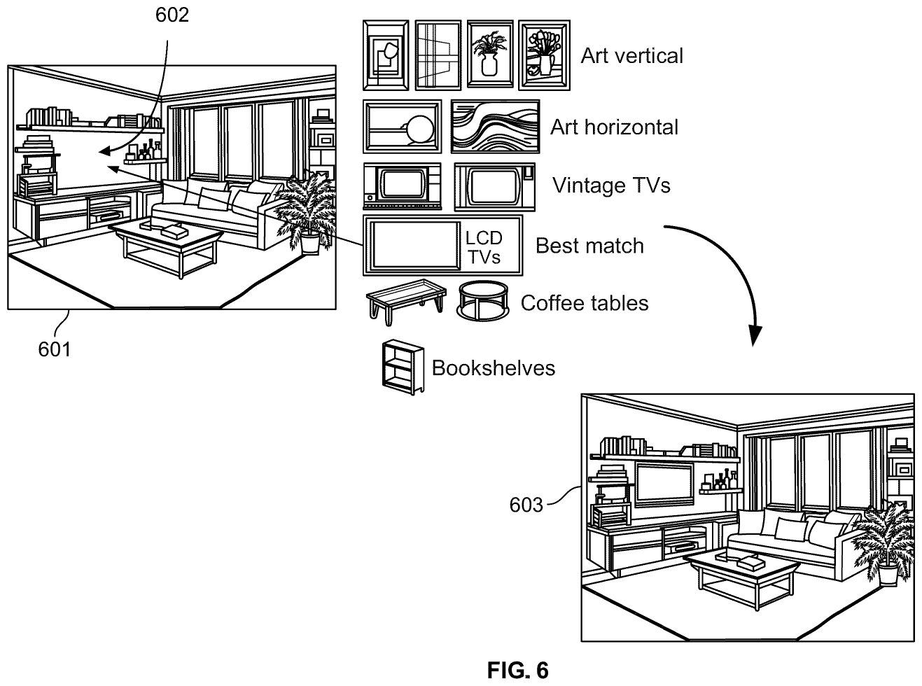

FIG. 6 shows an illustration of an example embodiment process of content selection system 100. The content selection system 100 obtains a mapping 601 of a user's living room, an environment 102, from a secondary device 210 such as an XR headset or a robotic vacuum cleaner. In the example shown in FIG. 6, the content selection system 100 generates for display a 3D rendering of the mapping 601 on, for example, a television screen where the television is a primary device 212. In similar embodiments, the content selection system 100 may display rendering on other devices such as a computer screen, smartphone, or XR headset. Next, the content selection system 100, using mapping 601, analyzes goods and/or services 104 in an object storage 222 and identifies objects relevant to the environment 102. In the embodiment shown in FIG. 6, the objects in objects storage 222 include images of household items. Relevant goods and/or services 104 may be goods and/or services 104 that meet an identified need, physically fit the environment 102, or match a style of the environment 102. At this step content selection system 100 also determines that some goods and services 104 are not relevant. For example, the content selection system 100 identifies some goods and/or services 104 such as those in the coffee table and bookshelf categories as not relevant because the mapping 601 includes no location in which these objects can physically fit. The content selection system 100 determines, either as part of this analysis or after, an adequate location 602 for a series of objects. In the illustrated embodiment, the location 602 is an empty space on a wall of the living room that the content selection system 100 has identified using mapping 601. After identifying location 602, the content selection system 100 determines, for example, that products in the vintage TV category are too thick to fit in the identified installation zone because the installation zone is on a wall and requires a wall mounted television. The content selection system 100 further determines that items in the vertical art category also do not fit as they are small and only fill a limited portion of the identified installation zone, location 602. The content selection system 100 then determines that items in the horizontal art and LCD TV categories are prime candidates for the scanned space based on their utility and size. The content selection system 100 may then further refine these candidates based on data such as dimensions or price. The content selection system 100 may also rank the candidates using other information, such as user preferences, to further reduce or organize the list of potential candidates of goods in object storage 222 to only TV's most likely to fit the environment 102.

In the illustrated embodiment of FIG. 6, the content selection system 100 determines that the LCD TV is the best candidate. After having generated a list of best or selected TV's, extracted from object storage 222, that match the mapping 601, the content selection system 100 may then push a content item 603, here an image depicting the TV in the 3D rendering of the room, to a primary device 212. In similar embodiments, the content item 603 may be an AR overlay displayed on top of an image of a room on an AR display. In another embodiment, it may be a 3D depiction of an object in a VR environment. In some embodiments, the content item 603 is an advertisement and the image the TV in the room is integrated into the advertisement to create a personalized experience.

In some embodiments, the content selection system 100 may detect that a secondary device 210 is in a visited environment 102, such as a resort or an Airbnb, by recognizing that a scan is not of the typical surroundings, a stored environment, an existing 3D rendering, or any other mapping environment. Upon detection that the device is not at a usual living place, the content selection system 100 may also detect goods and/or services 104 at the visited place that the user may be interested in. For example, the user may have taken pictures of a decorative lamp, a dresser or a couch at the visited environment 102. The content selection system 100 may then recognize at least one object in these pictures as part of an object storage 222 and may also determine that such an object may fit within the usual living quarters using the scans or mappings 103 of the usual living quarters as described in the previous embodiments of this disclosure. In some embodiments, the introduction of a new object may prompt the content selection system 100 to determine and display an updated layout of environment 102. In some embodiments, the system 100 determines that the object may replace an existing object in environment 102. In some embodiments, the system 100 may use similar techniques to rearrange existing objects in environment 102, for example to update the layout of a room. In these embodiments, the content selection system 100 may rearrange objects based on the theme, style, or look and feel of an environment 102. Upon determining that at least one object in the object storage 222 fits the living quarters, the content selection system 100 may then elect to generate a content item 105 related to that object on a primary device 212. In some embodiments, the system 100 displays the content item 105 upon return of the device 210 to the usual living place to improve efficiently and the likelihood that the user positively receives the content item.

The content selection system 100 may also detect that another secondary device 210 of a different, second user is visiting the same visited environment 102 as the user and device 210 discussed above, but at a later date. In such embodiments the content selection system 100 may also upon determining that that object fits within the living quarters of the second user and second device 210, present a content item for the same object to the second user. The selection of the content item may, in some embodiments, be based on a mapping 103 of said living quarters, without the second device having to explicitly indicate interest in that object.

For example, FIG. 7 shows a example process 700 of content selection system 100 illustrating variations on process 300. The process 700 may be implemented, in whole or in part, by control circuitry including for example, processor 224. For example, one or more of the aforementioned devices, such as 210, may execute one or more instructions or routines stored to memory or storage of a device to implement, in whole or in part, the process 700. In some embodiments, portions of process 700 are implemented on a cloud server. In some embodiments, all steps 700 occur on one device.

At step 701 of process 700, content selection system 100 extracts environment information from a received mapping data of an area. The environment information may inform content selection system 100 regarding the environment 102, such as the layout, style, design, dimensions, objects, or other information. It may include spatial information and/or other data. Environment information may include, for example, at least one of available space, furniture arrangement, a catalog of recognized objects in the area, and/or placements of recognized objects in the area. Mapping data may be information regarding a mapping 103 of environment 102. For example, mapping data may be the mapping 103 itself or data from which content selection system 100 may create a mapping 103. In some embodiments, the content selection system 100 creates the mapping based on received data, such as scans or images of environment 102. Such scans and images may be obtained from device 210 using, for example, a camera or other sensor capable or capturing data related to environment 102. In some embodiments, the content selection system 100 does not create mapping 103 but instead receives the mapping 103 from another device. The content selection system 100 may receive the mapping data to input/output circuitry 226 from a secondary device 210, such as a camera, smartphone, or other device capable capturing data, a database, or other source. In some embodiments, content selection system 100 determines environment information from the mapping data using processor 224. In some embodiments, mapping data includes embedded data containing the environment information. In some embodiments, the environment information is determined based on a combination of receiving data and analyzing the data.

At step 702 the content selection system 100 accesses via a network 201a storage of supplemental content items such as object storage 222. The supplemental content source may be a third-party content source, such as an image or advertising database or service. In some embodiments, the supplemental content source includes a collection of content items 105 for selection. In some embodiments, each supplemental content item of the supplemental content source highlights a specific good or service, such as furniture, artwork, electronics, window cleaning, home remodeling, etc. The content items 105 may be images or advertisements containing the highlighted good or service.

At step 703 the content selection system 100 accesses from a profile data source, a user profile 228. The profile data source may be, for example, a database of user profiles, a memory of a user device, or a user account stored on a cloud server. The user profile may include information such as user preferences, history of objects and other details of environment 102, or other information. System 100 may continually update the user profile 228 upon receipt of new data, such as user settings updated mappings 103.

At step 704 content selection system 100 uses processor 224 to determine, based on the environment information, the storage of supplemental content items, and the user profile 228, a selected supplemental content item 105 from the storage of supplemental content items matches the environment 102. This selection may represent for example content item 105 that best addresses a deficiency in an environment 102 or that best fits the dimensions of environment 102 or an available space in environment 102. The selection may further reflect preferences such as style and budget.

At step 705 the content selection system 100 in response to the determining the selected supplemental content item matches environment 102, generates, using processor 224 and input/output circuitry 226, for display on a display device 212, the supplemental content item 105. For example, the content selection system 100 may select a content item 105 advertising a certain TV, such as the embodiment seen in FIG. 6. The content selection system 100 then displays that advertisement on a user device 212 such as a phone, television, or computer for a user to receive.

At step 706 the content selection system 100 in response to the determining the selected supplemental content item does not match environment 102, ends the process. In some embodiments, after 706 the process 700 may return to step 704 to select a second supplemental content item for consideration.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present disclosure includes. Furthermore, it should be noted that the features and limitations described in any an embodiment may be applied to any other embodiment herein, and flowcharts or examples relating to an embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
extracting environment information from received mapping data of an environment, wherein the environment information includes at least one of available space, a catalog of one or more recognized objects in the environment, or placement of the one or more recognized objects in the environment;
accessing a storage of supplemental content items;
identifying, from a profile data source, a user profile;
selecting, based on the environment information and the user profile, a supplemental content item from the storage of supplemental content items; and
generating, for display on a display device, the supplemental content item.

2. The method of claim 1, wherein selecting the supplemental content item comprises determining that an object related to the selected supplemental content item physically fits within the environment.

3. The method of claim 1, further comprising receiving via a first device the received mapping data, wherein the first device and the display device are different devices.

4. The method of claim 1, wherein the selected supplemental content item is an image or video of an object or service related to the supplemental content item.

5. The method of claim 1, further comprising receiving style information of the environment, and wherein selecting the supplemental content item is further based on the style information of the environment.

6. The method of claim 1, further comprising receiving historical information of the environment, and wherein selecting the supplemental content item is further based on the historical information of the environment.

7. The method of claim 1, wherein the received mapping data of the environment includes a three-dimensional scan of the environment.

8. The method of claim 1, wherein the user profile further includes indicated interest in an object, and wherein selecting the supplemental content item is further based on the indicated interest in an object.

9. The method of claim 1, further comprising extracting environment information from a received mapping data of a second environment, wherein selecting the supplemental content item is further based on the environment information of the second environment.

10. The method of claim 1, wherein the selecting, based on the environment information and the user profile, a supplemental content item is further based on a field of view of the display device, and wherein the environment extends beyond the field of view.

11. The method of claim 10, wherein the supplemental content item is a representation of an object;
wherein the generating, for display on a display device, the supplemental content item further comprises generating for display the representation of the object in the field of view; and
wherein the selecting of the supplemental content item is further based on recognized objects in the environment outside of the field of view.

12. A system comprising:
control circuitry configured to:
extract environment information from received mapping data of an environment, wherein the environment information includes at least one of available space, a catalog of one or more recognized objects in the environment, or placement of the one or more recognized objects in the environment;
access a storage of supplemental content items;
identify, from a profile data source, a user profile;
select, based on the environment information and the user profile, a supplemental content item from the storage of supplemental content items; and
generate, for display on a display device, the supplemental content item.

13. The system of claim 12, wherein to select the supplemental content item is by determining that an object related to the selected supplemental content item physically fits within the environment.

14. The system of claim 12, the control circuitry further configured to receive via a first device the received mapping data, wherein the first device and the display device are different devices.

15. The system of claim 12, wherein the selected supplemental content item is an image or video of an object or service related to the supplemental content item.

16. The system of claim 12, the control circuitry further configured to receive style information of the environment, and wherein to select the supplemental content item is further based on the style information of the environment.

17. The system of claim 12, wherein the control circuitry is further configured to receive historical information of the environment, and wherein to select the supplemental content item is based on the historical information of the environment.

18. The system of claim 12, wherein the received mapping data of the environment includes a three-dimensional scan of the environment.

19. The system of claim 12, wherein the user profile further includes indicated interest in an object, and wherein selecting the supplemental content item is further based on the indicated interest in an object.

20. The system of claim 12, the control circuitry further configured to extract environment information from a received mapping data of a second environment, wherein to select the supplemental content item is based on the environment information of the second environment.

21-55. (canceled)
